(19) United States
(12) Patent Application Publication
(10) Pub. No.: US 2026/0209443 A1
(43) Pub. Date: Jul. 23, 2026

(54) Thermally Conductive Silicone Adhesive

(71) Applicant: Henkel AG & Co. KGaA, Duesseldorf (DE)

(72) Inventors: Jianfeng Zhang, Irvine, CA (US); Qizhuo Zhuo, Irvine, CA (US); Jay Chao, Irvine, CA (US); Sreevalli Bokka, Irvine, CA (US)

(21) Appl. No.: 19/570,739

(22) Filed: Mar. 18, 2026

Related U.S. Application Data
(63) Continuation of application No. PCT/US2024/048854, filed on Sep. 27, 2024.
(60) Provisional application No. 63/590,025, filed on Oct. 13, 2023.

(51) Int. Cl. C08G 77/20; C08G 77/08; C08G 77/12; C08K 3/08; C08K 5/5425; C08K 5/5455; C09J 5/00; C09J 9/00; C09J 183/04

(52) U.S. Cl. CPC C08G 77/20; C08G 77/08; C08G 77/12; C08K 3/08; C08K 5/5425; C08K 5/5455; C09J 5/00; C09J 9/00; C09J 183/04; C08K 2003/0806; C08K 2201/001; C09J 2203/326; C09J 2301/408; C09J 2483/00

(57) ABSTRACT

A thermally conductive silicone adhesive that exhibits both high thermal conductivity and high adhesion strength which is prepared from a curable composition including reactable organosiloxanes and thermally conductive particulate filler and is useful in dissipating excess thermal energy in electronic packages.

### FIELD OF THE INVENTION

The present invention relates to thermally conductive adhesives for electronic assemblies generally, and more particularly to curable silicone-based adhesives that exhibit high thermal conductivity and high adhesion strength.

### BACKGROUND OF THE INVENTION

As electronic devices such as semiconductors are produced with increasing complexity and power density, advances are continuously sought for thermal management solutions. Typical thermal management solutions in electronic packages involve thermally conductive sheets or pads that are pre-formed with a given shape and thickness, greases that serve as a gap filler, phase changing polymers, form in place materials, and adhesives that can cure to develop adhesion at substrate interfaces. In all cases, the thermal management solution is disposed along a thermal dissipation pathway to facilitate heat transfer from the heat-generating electronic component.

Thermally conductive sheets or pads can be provided with relatively high thermal conductivity values exceeding 2 W/m*K but have limitations due to their pre-formed shape and thickness. For example, positioning of the conductive sheet along the thermal dissipation pathway often requires a compression load upon adjacent surfaces bracketing the conductive sheet. The loads required to create good contact among the adjacent surfaces and the conductive sheet can damage the electronic components and their connections.

Thermally conductive greases possess good contactability and require low to no-load application for placement along the thermal dissipation pathway. However, thermally conductive greases are often characterized as “messy”, and may be difficult to apply due to their high viscosities. Thermally conductive greases can also tend to out flow from their desired position during use as a result of compression forces and elevated operating temperatures which reduce form stability. This can contaminate neighboring components, and also reduce thermal transfer effectiveness of the interface. Efforts to improve surface bonding and form stability of thermally conductive greases have met limited success, in part to due aging problems such as reduced break elongation over operation time.

Although some conventional thermally conductive materials exhibit high thermal conductivity, those exhibiting a high thermal conductivity tend to exhibit an insufficient adhesion strength. For example, peeling can occur between the thermally conductive material and the heat-generating electronic component or the heat dissipater, which results in an increase in thermal resistance.

Thermally conductive adhesives can offer a superior mechanical bond strength and long-term reliability. However, thermal conductivity is often a trade-off with adhesive force, wherein high thermal conductivity values in adhesives typically require high filler loading levels, which tend to stiffen the material and reduce adhesion strength. Although efforts have been made to improve both thermal conductivity and adhesion strength in a single solution, known adhesive materials fail to achieve a combination of high thermal conductivity (>3 W/m*K) and high adhesion strength (>3 MPa). Data taken from Dow literature shows the difficulty of providing a curable, conductive silicone adhesive having both desirable thermal conductivity (TC) and desirable adhesion strength (indicated below as Shear strength).

| | TC (W/mK) | Shear strength |
|---|---|---|
| DA6534 (Dow) | 6.8 | 1.4 MPa (Al) |
| DA6524 (Dow) | 2.1 | 1.7 Mpa (Al) |
| DA6523 (Dow) | 1.8 | 2.1 MPa |
| EC-6601 (Dow) | 2.12 | 1.7 MPa (Al surface) |
| EC-8425 (Dow) | 1.48 | 5 MPa (Al/Al) |

The Dow literature shows an inverse relationship between thermal conductivity and adhesion strength with higher thermal conductivity compositions having low strengths and high strength compositions having low thermal conductivity.

Accordingly, a need exists for a thermally conductive adhesive composition that is effective in bridging large coefficient of thermal expansion (CTE) mismatch between surfaces along a thermal dissipation pathway, while also exhibiting high thermal conductivity in excess of 3 W/m*K.

It is an object of the invention to provide a thermally conductive adhesive that demonstrates improved stress management and thermal management, and which can find application in various industries.

It is another object of the invention to provide a curable silicone composition for the preparation of thermally conductive silicone adhesives having good thermal conductivity (>3 W/m*K) and adhesion strength (>3 MPa) for use in thermal management applications requiring stress buffering.

### SUMMARY OF THE INVENTION

By means of the present invention, components may be securely affixed in an assembly that facilitates efficient thermal dissipation. Heat-generating components, such as electronic devices, may accordingly be packaged with heat dissipaters with high durability and high effective heat transfer of excess thermal energy. The package is assembled with a thermally conductive adhesive of the present invention that exhibits a thermal conductivity of at least 3 W/m*K, and an adhesion strength of at least 3 Mpa.

In one embodiment, a curable composition for preparing a thermally conductive adhesive includes an organosiloxane preparation having a first reactive organosiloxane having at least one unsaturated group, and a second reactive organosiloxane including at least about one silicon hydride functional group and at least about one alkenyl group. In addition to the organosiloxane preparation, the curable composition includes an organosiloxane including an average of at least two silicon-bonded hydrogen atoms per molecule in an amount effective to cure the composition. The curable composition further includes thermally conductive particulate filler such that the thermally conductive adhesive exhibits a thermal conductivity of at least 3 W/m*K and an adhesion strength of at least 3 MPa.

In some embodiments, the first organosiloxane includes an average of at least about one alkenyl groups per molecule. The first organosiloxane may, in some embodiments, include an average of at least 1.05 alkenyl groups per molecule.

In some embodiments, the thermally conductive particulate filler may be selected from metals such as nickel, copper, silver, gold, palladium, platinum, and mixtures and alloys thereof.

In some embodiments, the curable composition may include an adhesion promoter selected from an organosilane, and organotitanate, and combinations thereof.

A catalyst may be present in a catalytic amount to facilitate the curing of the composition. In some embodiments, the catalyst may be selected from hydrosilylation catalysts including platinum-based catalysts, ruthenium-based catalysts, palladium-based catalysts, osmium-based catalysts, iridium-based catalysts, titanium-based catalysts, and rhodium-based catalysts.

In some embodiments, a reaction inhibitor may be included to inhibit a hydrosilylation reaction of the curable composition. The reaction inhibitor may be selected from acetylenic alcohols, fumarate compounds, maleate compounds, and combinations thereof.

The curable composition may be provided as a one component (1K) composition including all of the components in a single, commercially storage stable composition or a multi-part (2K) composition including a first part and a second or more parts that are initially separate from the first part, wherein the first part does not include the organosiloxane having an average of at least two silicon-bonded hydrogen atoms per molecule. In the multi-part composition, the parts are mixed just before use and the mixture is not commercially storage stable.

In some embodiments, the first organosiloxane may have the following formula:

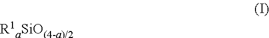

wherein: each R¹ is an alkenyl group or a hydrocarbon having between 1 and 60 carbon atoms; and
   “a” is a positive number between 1.05 and 3.95.

In some embodiments, the first organosiloxane includes at least two unsaturated groups per molecule. The first organosiloxane may exhibit a viscosity of between 0.1 and 100,000 cP at 25° C. at a shear rate of 1 s⁻¹.

The second organosiloxane may have the following formula:

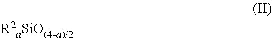

wherein: each R² is one of hydrogen, an alkenyl group, or a hydrocarbon having between 1 and 60 carbon atoms; and
   “a” is a positive number between 1.05 and 3.95.

The second organosiloxane may exhibit a viscosity of between 0.1 and 100,000 cP at 25° C. and at a shear rate of 1 s⁻¹.

In another embodiment, a thermally conductive adhesive includes the reaction product of:
(A) an organosiloxane preparation including:
   (i) a first reactive organosiloxane having at least one reactive unsaturated group; and
   (ii) a second reactive organosiloxane including at least about one silicon hydride functional group and at least about one alkenyl group; and
(B) an organosiloxane including an average of at least two silicon-bonded hydrogen atoms per molecule.

At least one of Components (A) and (B) may include thermally conductive particulate filler, such that the thermally conductive adhesive exhibits a thermal conductivity of at least 3 W/m*K and an adhesion strength of at least 3 MPa.

In some multi-part embodiments, Components (A) and (B) may be initially separate.

A package of the present invention may include an electronic component and a thermally conductive adhesive adhered to the electronic component. The thermally conductive adhesive may include Components (A) and (B) above, along with thermally conductive particulate filler. The package may further include a heat dissipater, wherein the thermally conductive adhesive may be adhered between the electronic component and the heat dissipater.

A method for making a package in accordance with the present invention includes providing a composition having:
(i) a first reactive organosiloxane including an average of at least about one alkenyl group per molecule, and a second reactive organosiloxane including at least about one silicon hydride functional group and at least about one alkenyl group;
(ii) an unsaturated organosiloxane; and
(iii) a thermally conductive particulate filler in at least one of (i) or (ii).

The method further includes dispensing the composition to a surface of at least one of a heat dissipater and an electronic component, and, optionally in the presence of a catalytic amount of a catalyst, reacting the first part with the second part.

The electronic component may then be secured to the heat dissipater with the composition disposed along a thermal dissipation pathway from the electronic component.

In some embodiments, the method further includes curing the composition by exposing the composition to a temperature of up to 300° C. for a cure time period. In some embodiments, the cure time period is less than 2 hours.

### BRIEF DESCRIPTION OF THE DRAWINGS

FIG. 1 is a cross-sectional view of an electronic package of the present invention.

### DETAILED DESCRIPTION OF THE INVENTION

The objects and advantages enumerated above together with other objects, features, and advances represented by the present invention are now described in terms of detailed embodiments. Other embodiments and aspects of the invention, however, are recognized as being within the grasp of those having ordinary skill in the art.

Generally, a thermally conductive adhesive may be prepared from a curable composition including the following components:
(A) an organosiloxane having an average of at least about one alkenyl groups per molecule;
(B) an organosiloxane having at least about one silicon hydride functional group and at least about one alkenyl group;
(C) an organosiloxane containing at least two silicon-bonded hydrogen atoms per molecule;
(D) thermally conductive filler;
(E) a hydrosilylation catalyst; and
(F) optional additional components.

In some embodiments, the curable composition is curable at temperatures of up to 300° C. for a cure period. In some embodiments, the cure period is less than 2 hours. The cured thermally conductive adhesive may exhibit a thermal conductivity of at least 3 W/m*K and an adhesion strength of at least 3 MPa.

### Component (A)

In an embodiment, Component (A) has the formula of:

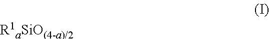

wherein: each R¹ is an alkenyl group or a hydrocarbon having between 1 and 60 carbon atoms; and
   “a” is a positive number between 1.05 and 3.95. “a” can be an integer, however for branched molecules “a” can have a fractional (non-integer) value.

Examples of the R¹ alkenyl group or a hydrocarbon having between 1 and 60 carbon atoms, in some embodiments between 2 and 50 carbon atoms, and in some embodiments between 2 and 20 carbon atoms. include alkyl groups such as a methyl group, an ethyl group, a propyl group, a butyl group, a pentyl group, a hexyl group, a heptyl group, an octyl group, a nonyl group, a decyl group, a phenyl group, a dodecyl group, a tetradecyl group, a hexadecyl group, and an octadecyl group; cycloalkyl groups such as a cyclopentyl group and a cyclohexyl group; alkenyl groups such as a vinyl group and an allyl group; aryl groups such as a tolyl group; aralkyl groups such as 2-phenylethyl group and 2-methyl-2-phenylethyl group, and halogenated hydrocarbon groups such as 3,3,3-trifluoropropyl group. The alkenyl groups may be bonded to silicon atoms present at molecular chain terminals and/or silicon atoms present at moieties on the molecular chain other than the terminals.

Component (A) may have a linear structure, a partially branched linear structure, a branched structure, a cyclic structure, and a three-dimensional network structure such as a silicone resin with functional siloxane monomeric units selected from Me₃SiO, MeSiO₃, SiO₄, and combinations thereof. In an example, a linear diorganopolysiloxane having a main chain having repeating diorganosiloxane units and having both of its molecular chain terminals blocked by triorganosiloxy groups.

Component (A) may be a polyorganosiloxane having an average, per molecule, of at least 2 aliphatically unsaturated organic groups, which are capable of undergoing a hydrosilylation reaction with a silicon-bonded hydrogen atom of Components B and/or C. In some embodiments, Component (A) includes at least two reactive alkenyl groups, at least two reactive alkynyl groups, or at least one reactive alkenyl group and at least one reactive alkynyl group. In other embodiments, Component (A) includes at least one reactive unsaturated group and at least one silicon-bonded hydrogen atom. In some embodiments, Component (A) includes at least two reactive unsaturated groups and at least one silicon-bonded hydrogen atom.

Component (A) can have a viscosity of about 2 cps to 9,000,000 cps. In some embodiments Component (A) can have a viscosity of about 10 cps-100000 cps. In some embodiments Component (A) can have a viscosity of about 10 cps-10000 cps.

In some embodiments, Component (A) may include a polydiorganosiloxane such as dimethylvinylsiloxy-terminated polydimethylsiloxane; dimethylvinylsiloxy-terminated poly(dimethylsiloxane/methylvinylsiloxane); dimethylvinylsiloxy-terminated polymethylvinylsiloxane; trimethylsiloxy-terminated poly(dimethylsiloxane/methylvinylsiloxane, vinyl terminated (phenylmethylsiloxane) vinylphenylsiloxane copolymer, vinyl terminated (diphenylsiloxane) dimethylsiloxane copolymer, vinyl terminated (diphenylsiloxane)-dimethylsiloxane copolymer, (phenylmethylsiloxane) vinylphenylsiloxane copolymer, (phenylmethylsiloxane) vinylmethylsiloxane copolymer, and combinations thereof.

### Component (B)

In an embodiment, Component (B) has the formula of:

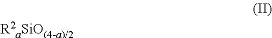

wherein: each R² is one of hydrogen, an alkenyl group, or a hydrocarbon having between 1 and 60 carbon atoms; and
   “a” is a positive number between 1.05 and 3.95. “a” can be an integer, however for branched molecules “a” can have a fractional (non-integer) value.

Examples of the R² alkenyl group or a hydrocarbon having between 1 and 60 carbon atoms, in some embodiments between 2 and 50 carbon atoms, and in some embodiments between 2 and 20 carbon atoms. include alkyl groups such as a methyl group, an ethyl group, a propyl group, a butyl group, a pentyl group, a hexyl group, a heptyl group, an octyl group, a nonyl group, a decyl group, a phenyl group, a dodecyl group, a tetradecyl group, a hexadecyl group, and an octadecyl group; cycloalkyl groups such as a cyclopentyl group and a cyclohexyl group; alkenyl groups such as a vinyl group and an allyl group; aryl groups such as a tolyl group; aralkyl groups such as 2-phenylethyl group and 2-methyl-2-phenylethyl group, and halogenated hydrocarbon groups such as 3,3,3-trifluoropropyl group. The alkenyl groups may be bonded to silicon atoms present at molecular chain terminals and/or silicon atoms present at moieties on the molecular chain other than the terminals. Component (B) may have a linear structure, a partially branched linear structure, a branched structure, a cyclic structure, and a three-dimensional network structure such as a silicone resin with functional siloxane monomeric units selected from Me₃SiO, MeSiO₃, SiO₄, and combinations thereof. In an example, a linear dioganopolysiloxane having a main chain having repeating diorganosiloxane units and having both of its molecular chain terminals blocked by triorganosiloxy groups.

Component (B) may be a polyorganosiloxane having an average, per molecule, of at least one reactive silicon hydride and at least one alkenyl group. In some embodiments,

Component (B) includes at least one silicon-bonded hydrogen atom and at least one reactive unsaturated group per molecule. In some embodiments, Component (B) includes at least one silicon-bonded hydrogen atom and at least two reactive unsaturated groups per molecule. Typically, the alkenyl group will be at a terminal position on the molecule and the hydride group can be terminal or pendant.

Component (B) can have a viscosity of about 2 cps to 9,000,000 cps. In some embodiments Component (B) can have a viscosity of about 10 cps-100000 cps. In some embodiments Component (B) can have a viscosity of about 10 cps-10000 cps.

### Component (C)

In an embodiment, Component (C) has the formula of:

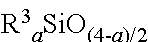

wherein: each R³ is one of hydrogen or a hydrocarbon having between 1 and 60 carbon atoms; and
“a” is a positive number between 1.05 and 3.95. “a” can be an integer, however for branched molecules “a” can have a fractional (non-integer) value.

Examples of the R³ hydrocarbons having between 1 and 60 carbon atoms, in some embodiments between 2 and 50 carbon atoms, and in some embodiments between 2 and 20 carbon atoms. include alkyl groups such as a methyl group, an ethyl group, a propyl group, a butyl group, a pentyl group, a hexyl group, a heptyl group, an octyl group, a nonyl group, a decyl group, a phenyl group, a dodecyl group, a tetradecyl group, a hexadecyl group, and an octadecyl group; cycloalkyl groups such as a cyclopentyl group and a cyclohexyl group.

Component (C) may have a linear structure, a partially branched linear structure, a branched structure, a cyclic structure, and a three-dimensional network structure such as a silicone resin with functional siloxane monomeric units selected from Me₃SiO, MeSiO₃, SiO₄, and combinations thereof. In an example, a linear dioganopolysiloxane having a main chain having repeating diorganosiloxane units and having both of its molecular chain terminals blocked by triorganosiloxy groups.

Component (C) may be a polyorganosiloxane having an average, per molecule, of at least two silicon-bonded hydrogen atoms, typically between 2 and 300 silicon-bonded hydrogen atoms, and preferably between 2 and 100 silicon-bonded hydrogen atoms. The hydrogen atoms in Component (C) may be bonded to silicon atoms present at molecular chain terminals and/or silicon atoms present at moieties on the molecular chain other than the terminals.

Organic groups other than the hydrogen atoms may be bonded to silicon atoms as well. Examples of such organic groups include alkyl groups such as a methyl group, an ethyl group, a propyl group, a butyl group, a pentyl group, a hexyl group and a heptyl group; aryl groups such as a phenyl group, a tolyl group, a xylyl group and a naphthyl group; aralkyl groups such as a benzyl group and a phenethyl group; and halogenated alkyl groups such as a chloromethyl group.

In some embodiments, Components (A), (B), and (C) together are present in an amount of between 1 and 50 wt. % of the curable composition. In some embodiments, Components (A), (B), and (C) together are present in an amount of between 2 and 30 wt. % of the curable composition. In some embodiments, Components (A), (B), and (C) together are present in an amount of between 5 and 20 wt. % of the curable composition. In some embodiments, Components (A), (B), and (C) together are present in an amount of between 10 and 15 wt. % of the curable composition.

In some embodiments, Component (C) is present in an amount of between 0.5 and 99.5% relative to a total amount of Components (A), (B), and (C) together in the curable composition. In some embodiments, Component (C) is present in an amount of between 0.5 and 50% relative to a total amount of Components (A), (B), and (C) together in the curable composition. In some embodiments, Component (C) is present in an amount of between 0.5 and 10% relative to a total amount of Components (A), (B), and (C) together in the curable composition. In some embodiments, Component (C) is present in an amount of between 1 and 5% relative to a total amount of Components (A), (B), and (C) together in the curable composition.

In some embodiments, the reaction product of the silicone resins of Components (A), (B), and (C) are heat curable. In some embodiments, the heat cure is a hydrolysis-polymerization reaction at temperatures of up to 300° C. Thus, electronic devices of the packages of the present invention may be adhered to a substrate at temperatures of 300° C. or lower.

In some embodiments, a ratio of silicon-bonded hydrogen atoms to vinyl groups in the curable composition is between 0.1:1 and 100:1. In some embodiments, a ratio of silicon-bonded hydrogen atoms to vinyl groups in the curable composition is between 0.5:1 and 50:1. In some embodiments, a ratio of silicon-bonded hydrogen atoms to vinyl groups in the curable composition is between 1:1 and 10:1. In some embodiments, a ratio of silicon-bonded hydrogen atoms to vinyl groups in the curable composition is between 1.2:1 and 5:1.

### Component (D)

Component (D) is a particulate filler having a thermal conductivity of not less than 10 W/m*K, and preferably at least 20 W/m*K. In some embodiments, the particulate filler has an average particle size (d₅₀) of between 0.1 and 250 μm. In some embodiments, the particulate filler has an average particle size (d₅₀) of between 0.1 and 100 μm. In some embodiments, the particulate filler has an average particle size (d₅₀) of between 0.2 and 100 μm. In some embodiments, the distribution of thermally conductive particulate filler is not a mono dispersion, but rather a particle size distribution. In some embodiments, the particle size distribution is multi-modal, including a mixture of relatively small particles and relatively large particles, within the size ranges described above. For the purposes hereof, the term “average particle size” refers to a cumulative weight average value (d₅₀) in which 50% of the particles are larger than the value, and 50% of the particles are smaller than the value, as determined by laser light diffraction. Component (D) may be dispersed in the polymer matrix, and may be electrically conductive or electrically insulative, as the application demands. Examples of thermally conductive particulate filler include particles or powders of nickel, copper, silver, gold, platinum, palladium, aluminum, diamond, carbon, indium, gallium, zinc oxide, titanium oxide, magnesium oxide, alumina, aluminum hydroxide, boron nitride, aluminum nitride, and mixtures and alloys thereof. In some embodiments, the particulate filler may be electrically conductive by having at least an outer surface of a metal selected from nickel, copper, silver, gold, platinum, palladium, and alloys thereof. The shape of the particulate filler may be spherical, aspherical, and combinations thereof. Example aspherical shapes include flake-like, plate-like, rod-like, and so on. Spherical particulate filler may have an aspect ratio of between 0.8-1.2.

The thermally conductive particulate filler is present in an amount sufficient to provide the adhesive with a high degree of thermal conductivity. In some embodiments, the adhesive exhibits a thermal conductivity of at least 3 W/m*K. In some embodiments, the adhesive exhibits a thermal conductivity of at least 5 W/m*K. In some embodiments, the adhesive exhibits a thermal conductivity of at least 7 W/m*K. In some embodiments, the adhesive exhibits a thermal conductivity of at least 9 W/m*K.

In order to achieve the high thermal conductivity values of the present invention, the thermally conductive particulate filler may be present in an amount of at least 80 wt. % of the adhesive. In some embodiments, the thermally conductive filler may be present in an amount of between 80 and 95 wt. % of the adhesive. In some embodiments, the thermally conductive filler may be present in an amount of between 85 and 95 wt. % of the adhesive.

If necessary, Component (D) may also be hydrophobized with, for example, organosilane, organosilazane, ogranopolysiloxane, and an organic fluorine compound.

### Component (E)

Component (E) is a catalyst effective for catalyzing a hydrosilylation reaction. The catalyst of Component (E) may be selected from a platinum-based catalyst, a ruthenium-based catalyst, a palladium-based catalyst, an osmium-based catalyst, an iridium-based catalyst, a titanium-based catalyst, and a rhodium-based catalyst. In some embodiments, the composition of the present invention may be converted to a curable composition with the presence of the catalyst of Component (E). However, it is contemplated that the curable compositions of the present invention do not require Component (E) for reaction.

In the compositions of the present invention, Component (E) is present in an amount required for curing the composition, which is referred to as the catalytic amount. In some embodiments, Component (E) may be present in an amount of between 0.1 and 1000 ppm mass of the organosiloxane. In some embodiments, Component (E) may be present in an amount of between 0.1 and 500 ppm mass of the organosiloxane. In some embodiments, Component (E) may be present in an amount of between 0.1 and 100 ppm mass of the organosiloxane. In some embodiments, Component (E) may be present in an amount of between 1 and 50 ppm mass of the organosiloxane. In some embodiments, Component (E) may be present in an amount of between 15 and 35 ppm of the organosiloxane.

In order to control the curing speed of the composition of the present invention, a curing reaction inhibitor may be included in the curable composition. Inhibitors useful in the present invention include inhibitors for hydrosilylation, such as acetylene-based compounds including acetylenic alcohols, fumarate-based compounds, and maleate-based compounds. Although there are no limitations on the amount of curing reaction inhibitor used in the compositions of the present invention, example amounts include between 2 and 20,000 ppm mass of the organosiloxane. In some embodiments, the curing reaction inhibitor is present in an amount of between 20 and 5,000 ppm mass of the organosiloxane. In some embodiments, the curing reaction inhibitor is present in an amount of between 300 and 3,500 ppm mass of the organosiloxane in the compositions of the present invention.

In some embodiments, a ratio by mass of curing reaction inhibitor to reaction catalyst may be between 10:1 and 500:1. In some embodiments, a ratio by mass of curing reaction inhibitor to reaction catalyst may be between 20:1 and 200:1. In some embodiments, a ratio by mass of curing reaction inhibitor to reaction catalyst may be between 35:1 and 100:1.

The thermally conductive compositions of the present invention may further include one or more additional components, such as an adhesion promoter, a silicone diluent, a reactive diluent, a colorant, a corrosion inhibitor, an acid acceptor, silica carbon black, glass beads, metal particles, and combinations thereof. In some embodiments, one or more adhesion promotors may be present in an amount effective for building chemical bonding at an interface between the thermally conductive adhesive and adhered substrates. Adhesion promoters may be present in the compositions of the present invention in an amount of between 0 and 5 wt. % of the composition. In some embodiments, an adhesion promoter is present in an amount of between 0 and 2 wt. % of the composition. In some embodiments, an adhesion promoter is present in an amount of between 0.1 and 0.5 wt. % of the composition.

Examples of suitable adhesion promoters include organosilanes including monosilanes, dipodal silanes, tripodal silanes, and oligomer silanes with methoxy, ethoxy, and/or propyloxyl structure. An example alkoxysilane is as an epoxy-functional alkoxysilane. Other suitable adhesion promoters include organotitanates and mercapto-functional compounds.

Solvents may optionally be used in some embodiments. Preferably, the composition is free of solvents such as organic solvents to minimize volatile organic compound (VOC) content.

The thermally conductive compositions of the present invention may be used after being cured. In some embodiments, the thermally conductive compositions of the present invention may be cured at a temperature from about room temperature to about 300° C. In some embodiments, the thermally conductive compositions of the present invention may be cured when heated to a temperature of between 70° C. to about 200° C. In some embodiments, the thermally conductive compositions of the present invention may be cured when heated to a temperature of between 125° C. to 190° C.

A curing time may be at least one minute. In some embodiments, the curing time is less than 250 minutes. In some embodiments, the curing time is between 1 and 200 minutes. In some embodiments, the curing time is between 1 and 150 minutes.

The curable compositions of the present invention may be provided as a one-part (1K) composition or a multi-part composition including the components in two or more parts, provided that Components B, C, and E are not present in the same part. For a one part composition the components are mixed together with sufficient reaction inhibitor so that the resulting composition has a commercially acceptable storage time of weeks to one or more years while remaining useful. For a multipart composition, Component (E) cannot be present with Component (B) or C in the same part. Typically in a multipart composition any catalyst would be in the alkenyl silane component and separated from any hydride component.

The curable silicone compositions of the present invention may exhibit adjustable rheological performance and curing kinetics adapting to different processing in packaging applications, and low volatile organic compound (VOC) content. Moreover, the present silicone composition is curable to form a silicone adhesive having both excellent adhesion and thermal conductivity (and optionally electrical conductivity), as well as good reliability. Furthermore, the silicone compositions of the present invention are curable to form a silicone adhesive that exhibits excellent stress management buffering differences in coefficient of thermal expansion of the adhered parts, along with a substantially void-free bond line.

The cured adhesives of the present invention preferably exhibit an adhesion strength of at least 3 MPa. In some embodiments, the cured adhesives exhibit an adhesion strength of at least 5 MPa. In some embodiments, the cured adhesives exhibit an adhesion strength of at least 10 MPa. In some embodiments, the cured adhesives exhibit an adhesion strength of at least 20 MPa. The adhesion strength of the adhesives of the present invention is measured by the die shear test. In some embodiments, the die shear test may be performed by the Mil-Std-883 Method 2019.

The silicone compositions of the present invention are useful for preparing thermally conductive adhesives, which may be used in various applications, such as thermal interface materials in semiconductor packaging, die attach adhesives, and solder replacements. In a particular embodiment, the adhesives of the present invention may be useful for bonding electronic components to flexible or rigid substrates, and particularly interposed between the surface of a heat-generating electronic component and a heat dissipater.

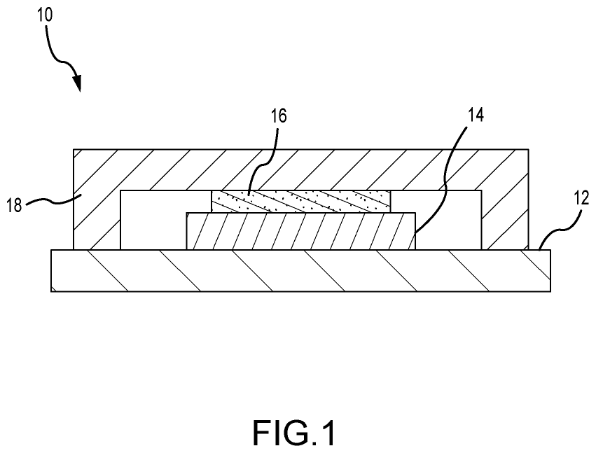

FIG. 1 schematically illustrates a package 10 of the present invention including a substrate 12, such as a printed circuit board; an electronic component 14, such as a semiconductor, processor, or the like; thermally conductive adhesive 16; and a heat dissipater 18, such as a heat sink or lid. The thermally conductive adhesive 16 is adhered between electronic component 14 and heat dissipater 18. In some embodiments, thermally conductive adhesive 16 may adhere heat dissipater 18 to electronic component 14.

In one embodiment, a curable composition of the present invention is dispensed to a surface of at least one of the electronic component 14 and heat dissipater 18, and the electronic component 14 is secured to the heat dissipater so that the composition is disposed along a thermal dissipation pathway from electronic component 14. In some embodiments, package 10 is formed by curing the composition for a cure time to establish a cured adhesive exhibiting a form-stable product. The composition may be cured by exposing the composition to a temperature of up to 300° C. for a cure time period of less than 2 hours.

### EXAMPLES

The following test methods were used in the Examples.

Viscosity was measured using a parallel plate viscometer at 5 rpm and room temperature.

Adhesion strength was measured on a Dage series 4000 die shear tester using a silicon die and a nickel-coated copper substrate at both room temperature and high temperature (260° C.).

Thermal conductivity of the bulk cured material was measured with a thermal conductivity tester (LFA 447 NanoFlash, commercially available from NETZSCH-Geratebau GmbH, Germany).

### Example 1

A one-part formulation was prepared in accordance with the following Table:

| Material | Weight (%) |
|---|---|
| SILQUEST A-174NT* | 0.900 |
| 3-Acrylamidopropyltrimethoxysilane | 0.137 |
| 1-ethynylcyclohexanol | 0.137 |
| Methyl hydrosiloxane dimethyl siloxane copolymer | 2.752 |
| Vinyl methyl dimethyl siloxane copolymer | 9.071 |
| Silver filler (Flake) | 87.000 |
| Pt catalyst | 0.003 |

*Described by the manufacturer as a methacryloxy functional trimethoxy silane.

The Methyl hydrosiloxane dimethyl siloxane copolymer contains an average of 5.55 mmol/g of Si—H, the Vinyl methyl dimethyl siloxane copolymer contains an average of 1.1 mmol/g of Vinyl functional group. The silver flake has a tap density ~5.1 g/cm³, and specific surface area ~0.16 m²/g, average diameter ~11.8 um (with D50 ~10.3) with fatty acid surface treatment.

The components were mixed in a double planetary mixer for 10 minutes under vacuum and cooling with chilled water. The mixed composition was cured by exposure to 150° C. for two hours. The cured silicone adhesive exhibited an adhesion strength between a silicon wafer and a nickel substrate of 6.1 MPa at room temperature, and 4.9 MPa at 260° C. The cured silicone adhesive exhibited a thermal conductivity of 5.7 W/m*K.

### Example 2

A one-part formulation was prepared in accordance with the following Table:

| Material | Weight (%) |
|---|---|
| SILQUEST A-174NT | 1.180 |
| 3-Acrylamidopropyltrimethoxysilane | 0.180 |
| 1-ethynylcyclohexanol | 0.180 |
| Methyl hydrosiloxane dimethyl siloxane copolymer | 3.600 |
| Vinyl methyl dimethyl siloxane copolymer | 11.856 |
| Silver filler (Flake) | 83.000 |
| Pt catalyst | 0.004 |

The Methyl hydrosiloxane dimethyl siloxane copolymer contains an average of 5.55 mmol/g of Si—H, the Vinyl methyl dimethyl siloxane copolymer contains an average of 1.1 mmol/g of Vinyl functional group. The silver flake has a tap density ~3.7 g/cm³, and specific surface area ~0.14 m²/g, average diameter ~13.7 um (with D50 ~12.1) with PEG silane as the surface treatment.

The components were mixed in a double planetary mixer for 10 minutes under vacuum and cooled with chilled water. The mixed composition was cured by exposure to 150° C. for two hours. The cured silicone adhesive exhibited an adhesion strength between a silicon wafer and a nickel substrate of 7 MPa at room temperature, and 4.7 MPa at 260° C. The cured silicone adhesive exhibited a thermal conductivity of 5.5 W/m*K.

1. A curable composition for preparing a thermally conductive adhesive, the curable composition comprising:
an organosiloxane preparation including:
(i) a first reactive organosiloxane having at least one unsaturated group; and
(ii) a second reactive organosiloxane including at least about one silicon hydride functional group and at least about one alkenyl group;
an organosiloxane including an average of at least two silicon-bonded hydrogen atoms per molecule, the organosiloxane being present in an amount effective to cure the composition; and
thermally conductive particulate filler, wherein the thermally conductive adhesive exhibits a thermal conductivity of at least 3 W/m*K and an adhesion strength of at least 3 MPa.

2. The curable composition of claim 1 wherein the first organosiloxane includes an average of at least about one alkenyl group per molecule.

3. The curable composition of claim 2 wherein the first organosiloxane includes an average of at least 1.05 alkenyl groups per molecule.

4. The curable composition of claim 2 wherein the first organosiloxane is absent a silicone hydride functional group.

5. The curable composition of claim 2 wherein the first organosiloxane is present in an amount effective to cure the organosiloxane preparation.

6. The curable composition of claim 1 wherein the thermally conductive particulate filler is selected from nickel, copper, silver, gold, palladium, platinum, and mixtures and alloys thereof.

7. The curable composition of claim 1, including an adhesion promoter selected from an organosilane, an organotitanate, and combinations thereof.

8. The curable composition of claim 1, including a catalyst present in a catalytic amount, the catalyst being selected from hydrosilylation catalysts including platinum-based catalysts, ruthenium-based catalysts, palladium-based catalysts, osmium-based catalysts, iridium-based catalysts, titanium-based catalysts, and rhodium-based catalysts.

9. The curable composition of claim 1, including a reaction inhibitor effective to inhibit a hydrosilylation reaction.

10. The curable composition of claim 9 wherein the reaction inhibitor is selected from acetylenic alcohols, fumarate compounds, maleate compounds, and combinations thereof.

11. The curable composition of claim 1, including a first part and a second part that is initially separate from the first part, wherein one of the first part and the second part does not include the organosiloxane including an average of at least two silicon-bonded hydrogen atoms per molecule.

12. The curable composition of claim 1, wherein the first organosiloxane has the following formula I: 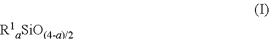
wherein: each R¹ is an alkenyl group or a hydrocarbon having between 1 and 60 carbon atoms; and
“a” is a positive number between 1.05 and 3.95.

13. The curable composition of claim 12 wherein the first organosiloxane includes at least two reactive unsaturated groups per molecule.

14. The curable composition of claim 13 wherein the organosiloxane exhibits a viscosity of between 0.1 and 100,000 cP at 25° C. at a shear rate of 1 s⁻¹.

15. The curable composition of claim 12 wherein the second organosiloxane has the following formula (II): 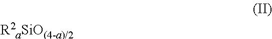
wherein: each R² is one of hydrogen, an alkenyl group, or a hydrocarbon having between 1 and 60 carbon atoms; and
“a” is a positive number between 1.05 and 3.95.

16. The curable composition of claim 15 wherein the second organosiloxane exhibits a viscosity of between 0.1 and 100,000 cP at 25° C. at a shear rate of 1 s⁻¹.

17. A thermally conductive adhesive comprising the reaction product of:
(A) an organosiloxane preparation including:
(i) a first reactive organosiloxane having at least one reactive unsaturated group; and
(ii) a second reactive organosiloxane including at least about one silicon hydride functional group and at least about one alkenyl group; and
(B) an organosiloxane including an average of at least two silicon-bonded hydrogen atoms per molecule,
wherein at least one of Components (A) and (B) include thermally conductive particulate filler, such that the thermally conductive adhesive exhibits a thermal conductivity of at least 3 W/m*K and an adhesion strength of at least 3 MPa.

18. The thermally conductive adhesive of claim 17 wherein Components (A) and (B) are initially separate.

19. A package, comprising:
an electronic component; and
the thermally conductive adhesive of claim 15 adhered to the electronic component.

20. The package of claim 17, including a heat dissipater, wherein the thermally conductive adhesive is adhered between the electronic component and the heat dissipater.

21. A method for making a package, the method comprising:
(a) providing a composition, comprising:
(i) a first part, including a first reactive organosiloxane including an average of at least about one alkenyl groups per molecule, and a second reactive organosiloxane including at least about one silicon hydride functional group and at least about one alkenyl group;
(ii) a second part, including an unsaturated organosiloxane; and
(iii) thermally conductive particulate filler in at least one of the first part and the second part;
(b) dispensing the composition to a surface of at least one of a heat dissipater and an electronic component;
(c) optionally in the presence of a catalytic amount of a catalyst, reacting the first part with the second part; and
(d) securing the electronic component to the heat dissipater with the composition disposed along a thermal dissipation pathway from the electronic component.

22. The method of claim 21 wherein the composition exhibits a thermal conductivity of at least 3 W/m*K and an adhesion strength of at least 3 MPa.

23. The method of claim 21, including curing the composition by exposing the composition to a temperature of up to 300° C. for a cure time period.

24. The method of claim 23 wherein the cure time period is less than 2 hours.
